(19) United States
(12) Patent Application Publication
(10) Pub. No.: US 2026/0139978 A1
(43) Pub. Date: May 21, 2026

(54) DEVICE AND METHOD FOR MEASURING FLUID FLOW AND PRESSURE UNDER HYPER-GRAVITY ENVIRONMENT

(71) Applicant: ZHEJIANG UNIVERSITY, Hangzhou (CN)

(72) Inventors: Yanbo CHEN, Hangzhou (CN); Yandong LV, Hangzhou (CN); Daosheng LING, Hangzhou (CN); Xiaowei YE, Hangzhou (CN); Hao LIU, Hangzhou (CN); Zixuan LI, Hangzhou (CN); Minghang ZOU, Hangzhou (CN); Ruohan WANG, Hangzhou (CN); Zhongduo LV, Hangzhou (CN)

(73) Assignee: ZHEJIANG UNIVERSITY, Hangzhou (CN)

(21) Appl. No.: 19/448,192

(22) Filed: Jan. 14, 2026

Related U.S. Application Data
(63) Continuation of application No. PCT/CN2024/120086, filed on Sep. 20, 2024.

(30) Foreign Application Priority Data
May 27, 2024 (CN) 202410662585.7

(51) Int. Cl. G01F 1/37; G01F 1/00; G01F 15/00; G01F 15/18; G01F 23/00; G01F 25/10; G01F 25/20

(52) U.S. Cl. CPC G01F 1/372; G01F 1/007; G01F 15/005; G01F 15/18; G01F 23/0007; G01F 25/10; G01F 25/24

(57) ABSTRACT

Provided are a device and a method for measuring fluid flow and pressure under a hyper-gravity environment. Two liquid reservoirs, a liquid level monitoring system, a flow monitoring system, a pumping system, and a pressure monitoring system are fixed to a base plate and disposed on a geotechnical centrifuge, where a flow pump is connected to an oil outlet of the geotechnical centrifuge; a pneumatic ball valve is provided with a gas source and connected to a gas outlet of the geotechnical centrifuge; and signals from the liquid level monitoring system, the flow monitoring system, the pumping system, and the pressure monitoring system are transmitted to a control center via a cable. The method includes: disposing the device on the geotechnical centrifuge, and acquiring fluid flow and pressure through the liquid level monitoring system and a pressure meter under a hyper-gravity environment.

### CROSS REFERENCE TO THE RELATED APPLICATIONS

This application is the continuation application of International Application No. PCT/CN2024/120086, filed on Sep. 20, 2024, which is based upon and claims priority to Chinese Patent Application No. 202410662585.7, filed on May 27, 2024, the entire contents of which are incorporated herein by reference.

### TECHNICAL FIELD

The present disclosure belongs to the field of fluid motion monitoring, and particularly relates to a device and method for measuring fluid flow and pressure under a hyper-gravity environment.

### BACKGROUND

Exploring the motion laws of matter under different gravity conditions has always been a topic of great interest. As an important research subject in the field of space science, the behavior of matter under microgravity conditions has been deeply investigated. Currently, research has begun to explore the motion laws of matter in nature by using the hyper-gravity approach. The hyper-gravity centrifuge, through the hyper-gravity field generated by centrifugal rotation, is an effective means to create a stable hyper-gravity field on Earth. Laboratory-scale physical tests using a hyper-gravity field can simulate real physical processes under normal gravity, restoring the stress level of large-scale media under normal gravity within small-scale media.

With the continuous development of centrifugal hyper-gravity technology, the transport of fluids such as water, gas, and slurry has become an inevitable requirement for onboard devices to develop towards complexity and high fidelity. Currently, Chinese Patent Application CN110987750A designs a one-dimensional seepage erosion test device under a hyper-gravity environment, which considers water transport and involves equipment such as centrifugal pumps and flowmeters. Chinese Patent Application CN116297105A designs a slurry seepage test device under a hyper-gravity environment, which considers slurry transport and involves equipment such as slurry pumps and pressure sensors. Research has found that conventional electromechanical equipment and sensors may malfunction or have limited functionality under hyper-gravity. Therefore, it is necessary to provide a testing method for fluid equipment and sensors under hyper-gravity, as well as a calibration method for flow generated by pressure water head and water head difference, and pumping flow, to ensure normal operation and functional realization of onboard devices.

### SUMMARY

To solve the problems mentioned in the background, the present disclosure provides a device and method for measuring fluid flow and pressure under a hyper-gravity environment generated by a geotechnical centrifuge, utilizing fluid circulation technology. The device and method greatly save time and economic costs and contribute to the development of onboard equipment of the geotechnical centrifuge.

The present disclosure adopts the following technical solutions.
1. A device for measuring fluid flow and pressure under a hyper-gravity environment includes:
a first liquid reservoir, a second liquid reservoir, a liquid level monitoring system, a flow monitoring system and a pumping system, where the first liquid reservoir and the second liquid reservoir are provided with the liquid level monitoring system; an outlet end of the first liquid reservoir communicates with an inlet end of the second liquid reservoir through the flow monitoring system; an outlet end of the second liquid reservoir communicates with an inlet end of the first liquid reservoir through the pumping system; the first liquid reservoir, the second liquid reservoir and the liquid level monitoring system are fixedly connected to a base plate; the base plate is disposed in a basket of a geotechnical centrifuge; and the liquid level monitoring system, the flow monitoring system and the pumping system are electrically connected to an external control center.
the liquid level monitoring system includes a liquid level sensor, a first liquid level switch module, a second liquid level switch module, two liquid level tubes, and seven industrial cameras; the liquid level sensor is disposed on an inner side wall of the first liquid reservoir, and is configured to measure a liquid level in the first liquid reservoir in real time; the two liquid level tubes are vertically disposed on side walls of the first liquid reservoir and the second liquid reservoir, respectively, and are configured to observe liquid level changes in the first liquid reservoir and the second liquid reservoir, respectively; the first liquid level switch module and the second liquid level switch module are disposed on the side walls of the first liquid reservoir and the second liquid reservoir, respectively; the first liquid level switch module mainly includes four liquid level indicator lights vertically arranged at intervals; the second liquid level switch module mainly includes three liquid level indicator lights vertically arranged at intervals; the seven industrial cameras are fixedly connected to the base plate via a bracket; and the seven industrial cameras are configured to acquire on/off states of the seven liquid level indicator lights, respectively; and
the liquid level sensor and the industrial cameras are electrically connected to the control center.
the flow monitoring system includes a flow pipe, a flowmeter, and a first pneumatic ball valve; the outlet end of the first liquid reservoir communicates with the inlet end of the second liquid reservoir through the flow pipe; the flowmeter and the first pneumatic ball valve are sequentially arranged on the flow pipe from the first liquid reservoir to the second liquid reservoir; and a gas inlet end of the first pneumatic ball valve communicates with a gas outlet of the geotechnical centrifuge; and
the device further includes two pressure sensors; the two pressure sensors are fixedly connected inside the first liquid reservoir and the second liquid reservoir, respectively; the pressure sensors are level with the flow pipe; the pressure sensors, the flowmeter and the first pneumatic ball valve are connected to the control center; and the control center is configured to control an opening degree of the first pneumatic ball valve, thereby controlling a fluid flow in the flow pipe.
the pumping system includes a pumping pipe, a flow pump, and a second pneumatic ball valve; the outlet end of the second liquid reservoir communicates with the inlet end of the first liquid reservoir through the pumping pipe; the second pneumatic ball valve and the flow pump are sequentially arranged on the pumping pipe from the second liquid reservoir to the first liquid reservoir; a gas inlet end of the second pneumatic ball valve communicates with the gas outlet (605) of the geotechnical centrifuge; an inlet end of the flow pump is connected to an oil outlet of the geotechnical centrifuge; the flow pump and the second pneumatic ball valve are connected to the control center; and the control center is configured to control an opening degree of the second pneumatic ball valve, thereby controlling a fluid flow in the pumping pipe.
the oil outlet of the geotechnical centrifuge communicates with the inlet end of the flow pump through a main pipe; an electromagnetic ball valve, a pressure reducing valve, a reversing valve, a proportional speed control valve, a pressure sensor and a gear flowmeter are sequentially arranged on the main pipe from the oil outlet to the flow pump; and the oil outlet of the geotechnical centrifuge further directly communicates with an oil inlet end of the flow pump through a secondary pipe.
2. A method for measuring fluid flow and pressure under a hyper-gravity environment includes following steps:
step S1: hoisting, by a crane, the entire device into a second basket of the geotechnical centrifuge; injecting clean water into the first liquid reservoir until a target liquid level H is reached; and connecting the liquid level monitoring system, the flow monitoring system and the pumping system to the control center;
step S2: starting the geotechnical centrifuge; opening the first pneumatic ball valve under a hyper-gravity environment, allowing the liquid in the first liquid reservoir to flow to the second liquid reservoir; and performing, during liquid flowing, a qualification test on the liquid level indicator lights and the liquid level sensor;
step S3: closing the first pneumatic ball valve and opening the second pneumatic ball valve when liquid levels in the first liquid reservoir and the second liquid reservoir are equal and the liquid stops flowing; pumping, by the flow pump, the water from the second liquid reservoir back to the first liquid reservoir; and performing, during liquid pumping, a qualification test on the flow pump;
proceeding to step S4 if the flow pump is qualified; and
otherwise, stopping a test process, replacing the unqualified flow pump, and repeating the step S3 until a test condition is met;
step S4: opening the first pneumatic ball valve, allowing the liquid in the first liquid reservoir to flow to the second liquid reservoir; and performing, during liquid flowing, a qualification test on a flowmeter and pressure sensors;
proceeding to step S5 if the flowmeter and the pressure sensors are qualified; and
otherwise, stopping the test process, replacing the unqualified flowmeter or any unqualified pressure sensor, and repeating the step S4 until a test condition is met;
step S5: closing the first pneumatic ball valve and opening the second pneumatic ball valve, when the liquid levels in the first liquid reservoir and the second liquid reservoir are equal and the liquid stops flowing; pumping, by the flow pump, the water from the second liquid reservoir back to the first liquid reservoir; and closing the second pneumatic ball valve and starting the first pneumatic ball valve after the water is completely pumped back to the first liquid reservoir; and
step S6: repeating the step S5 multiple times to achieve liquid circulation between the first liquid reservoir and the second liquid reservoir; and acquiring, during liquid circulation, a liquid pressure, a pumping flow of the flow pump, and a flow of the liquid under the action of a water head in real time by the pressure sensors, the gear flowmeter and the flowmeter, respectively.

The step S2 specifically includes:
step S2.1: starting the geotechnical centrifuge; gradually increasing a centrifugal acceleration of the geotechnical centrifuge to a preset Ng value; opening the first pneumatic ball valve after the centrifugal acceleration stabilizes, allowing the liquid in the first liquid reservoir to flow to the second liquid reservoir through the flow pipe under the action of a water head difference; and performing, during liquid flowing, a qualification test on the liquid level indicator lights and the liquid level sensor;
where, the qualification test on the liquid level indicator lights in the step S2.1 is specifically performed as follows: performing, during liquid flowing, the qualification test on the liquid level indicator lights based on readings of the transparent liquid level tubes:
determining that, if a liquid level corresponding to an on/off state of the liquid level indicator light is consistent with a liquid level in the liquid level tube, the liquid level indicator light is qualified; and
otherwise, determining that the liquid level indicator light is unqualified; and
the qualification test on the liquid level sensor in the step S2.1 is specifically performed as follows: performing, during liquid flowing, the qualification test on the liquid level sensor based on the reading of the transparent liquid level tube:
determining that, if a reading of the liquid level sensor is consistent with the liquid level in the liquid level tube, the liquid level sensor is qualified; and
otherwise, determining that the liquid level sensor is unqualified;
step S2.2: determining whether the liquid level switch module is qualified, where the liquid level switch module is qualified if the seven liquid level indicator lights meet following conditions:
a top liquid level indicator light in the first liquid level switch module is qualified;
a first liquid level indicator light from bottom to top in the first liquid level switch module is qualified or a first liquid level indicator light from top to bottom in the second liquid level switch module is qualified;
a second liquid level indicator light from bottom to top in the first liquid level switch module is qualified or a second liquid level indicator light from top to bottom in the second liquid level switch module is qualified; and
a third liquid level indicator light from bottom to top in the first liquid level switch module is qualified or a third liquid level indicator light from top to bottom in the second liquid level switch module is qualified; and
determining that, if the seven liquid level indicator lights in the liquid level switch module meet the above four conditions, the liquid level switch module is qualified; and otherwise, determining that the liquid level switch module is unqualified; and
step S2.3: proceeding to the step S3 if at least one of the liquid level switch module and the liquid level sensor is qualified; and
otherwise, stopping the test process, replacing the unqualified liquid level sensor or any unqualified liquid level indicator light, and repeating the steps S2.1 to S2.2 until a test condition is met.

The qualification test on the flow pump during liquid pumping in the step S3 is specifically performed as follows:
step S3.1: opening the electromagnetic ball valve, the pressure reducing valve, and the reversing valve; and adjusting the proportional speed control valve such that a reading of the gear flowmeter reaches a preset pumping hydraulic flow value;
step S3.2: denoting a time when the second pneumatic ball valve is opened as a start time T₁, and denoting a time when the liquid level in the first liquid reservoir reaches the target liquid level H as an end time T₂; and closing the second pneumatic ball valve, and acquiring a theoretical pumping hydraulic flow Q as follows:

$$Q = \frac{A \cdot H}{2 ( {T}_{1} - {T}_{2} )}$$

where, A denotes a cross-sectional area of the first liquid reservoir;
step S3.3: comparing the theoretical pumping hydraulic flow Q with the reading of the gear flowmeter;
determining that, if an error between the reading of the gear flowmeter and the theoretical pumping hydraulic flow Q is within ±5%, the flow pump is qualified during liquid pumping; and
otherwise, determining that the flow pump is unqualified.

The qualification test on the pressure sensors in the step S4 is specifically performed as follows:
acquiring a theoretical liquid pressure value Pₕ as follows:

$${P}_{h} = {ρω}^{2} ( {R}_{max} - {H}_{2} - \frac{h + {H}_{1}}{2} ) ( h - {H}_{1} )$$

where, Pₕ denotes a theoretical liquid pressure value corresponding to a liquid level h; ρ denotes a liquid density; ω denotes a rotational angular velocity of the geotechnical centrifuge; Rmax denotes a distance from a rotation axis center of the geotechnical centrifuge to a bottom surface of the second basket; h denotes a liquid level; H₁ denotes a distance from the pressure sensor to the bottom surface of the liquid reservoir (1) or the liquid reservoir (2); and H₂ denotes a distance from the bottom surface of the liquid reservoir (1) or the liquid reservoir (2) to the bottom surface of the second basket;
comparing the theoretical liquid pressure value Pₕ with readings of the pressure sensors at a same liquid level;
determining that, if an error between the readings of the pressure sensors and the theoretical pressure value Pₕ is within ±5%, the pressure sensors are qualified; and
otherwise, determining that the pressure sensors are unqualified.

The qualification test on the flowmeter in the step S4 is specifically performed as follows:
performing, if the liquid level switch module in the step S2.2 is qualified, the qualification test on the flowmeter through the liquid level indicator lights:
step S4.1: starting timing when the first pneumatic ball valve is opened; recording readings of the flowmeter every 1 s; recording a corresponding liquid level change time difference Δtᵢ (i=1, 2, 3) when the liquid level in the first liquid reservoir changes to a height of each of the qualified liquid level indicator lights in the liquid level switch module; and calculating a theoretical flow Q′ as follows:

$${Q}^{′} = \frac{A \cdot {ΔH}_{1}}{3 Δ {t}_{1}} + \frac{A \cdot {ΔH}_{2}}{3 Δ {t}_{2}} + \frac{A \cdot {ΔH}_{3}}{3 Δ {t}_{2}}$$

where, Δt₁ denotes a time required for the liquid level in the first liquid reservoir to drop by ΔH₁; Δt₂ denotes a time required for the liquid level in the first liquid reservoir to drop by ΔH₂; Δt₃ denotes a time required for the liquid level in the first liquid reservoir to drop by ΔH₃; ΔH₁ denotes the height difference between the first and second liquid level indicator lights from top to bottom in the first liquid level switch module; ΔH₂ denotes the height difference between the second and third liquid level indicator lights from top to bottom in the first liquid level switch module; and ΔH₃ denotes the height difference between the third and fourth liquid level indicator lights from top to bottom in the first liquid level switch module;
step S4.2: comparing the theoretical flow Q′ with a reading of the flowmeter;
determining that, if an error between the reading of the flowmeter and the theoretical flow Q′ is within ±5%, the flowmeter is qualified; and
otherwise, determining that the flowmeter is unqualified; and
performing, if the liquid level sensor is qualified in the step S2.1, the qualification test on the flowmeter through the liquid level sensor:
step S4.1: starting timing when the first pneumatic ball valve is opened, acquiring a reading change of the liquid level sensor within a random time period δt, and calculating a theoretical flow Q′ as follows:

$${Q}^{′} = \frac{A \cdot {H}_{δ t}}{δ t}$$

where, H_{δt} denotes a difference in readings of the liquid level sensor during the time period δt;
step S4.2: comparing the theoretical flow Q′ with a reading of the flowmeter:
determining that, if an error between the reading of the flowmeter and the theoretical flow Q′ is within ±5%, the flowmeter is qualified; and
otherwise, determining that the flowmeter is unqualified.

The first liquid reservoir, the second liquid reservoir, the liquid level monitoring system, the flow monitoring system, the pumping system, and the pressure monitoring system (pressure sensor) of the present disclosure are all fixed to the base plate and placed on the geotechnical centrifuge. The flow pump of the present disclosure is a hydraulic pump connected to the oil outlet of the geotechnical centrifuge. The pneumatic ball valve requires a gas source and is connected to the gas outlet of the geotechnical centrifuge. Signals from the liquid level monitoring system, the flow monitoring system, the pumping system, and the pressure monitoring system are all transmitted to the control center via a cable. The present disclosure aims to provide, under the hyper-gravity environment generated by the geotechnical centrifuge and utilizing fluid circulation technology, a device and method for simultaneously testing and calibrating equipment such as the flow pump, flowmeter, pressure sensor, and liquid level monitoring system in a single test.

The present disclosure has the following beneficial effects.
1. The present disclosure can derive the influence of different Ng values on fluid equipment and sensors under a hyper-gravity environment.
2. The present disclosure utilizes fluid circulation technology to simultaneously measure the flow generated by pressure water head, water head difference, and the pumping flow under hyper-gravity in a single test, saving test cost and time.
3. The device of the present disclosure has a high degree of mechanization, complete communication equipment, and logical operation steps, facilitating operation by test personnel.

### BRIEF DESCRIPTION OF THE DRAWINGS

FIG. 1 is a front view of a device in the present disclosure;

FIG. 2 is a top view of the device in the present disclosure;

FIG. 3 is a schematic diagram of a geotechnical centrifuge in the present disclosure; and

FIG. 4 is a schematic diagram of device connection in the present disclosure.

Reference Numerals: 1. first liquid reservoir; 2. second liquid reservoir; 3. base plate; 4. bracket; 5. connector; 6. geotechnical centrifuge; 7. flow pipe; 8. pumping pipe; 9. flowmeter; 10. flow pump; 11. first pneumatic ball valve; 12. second pneumatic ball valve; 13. liquid level sensor; 14. pressure sensor; 15. liquid level indicator light; 16. liquid level tube; 17. industrial camera; 18. image acquisition device; 19. cable; 20. control center; 21. electromagnetic ball valve; 22. pressure reducing valve; 23. reversing valve; 24. proportional speed control valve; 25. pressure sensor; 26. gear flowmeter; 601. first basket; 602. counterweight; 603. second basket; 604. rotating arm; 605. gas outlet; and 606. oil outlet.

### DETAILED DESCRIPTION OF THE EMBODIMENTS

The present disclosure will be further described below in conjunction with the drawings and embodiments.

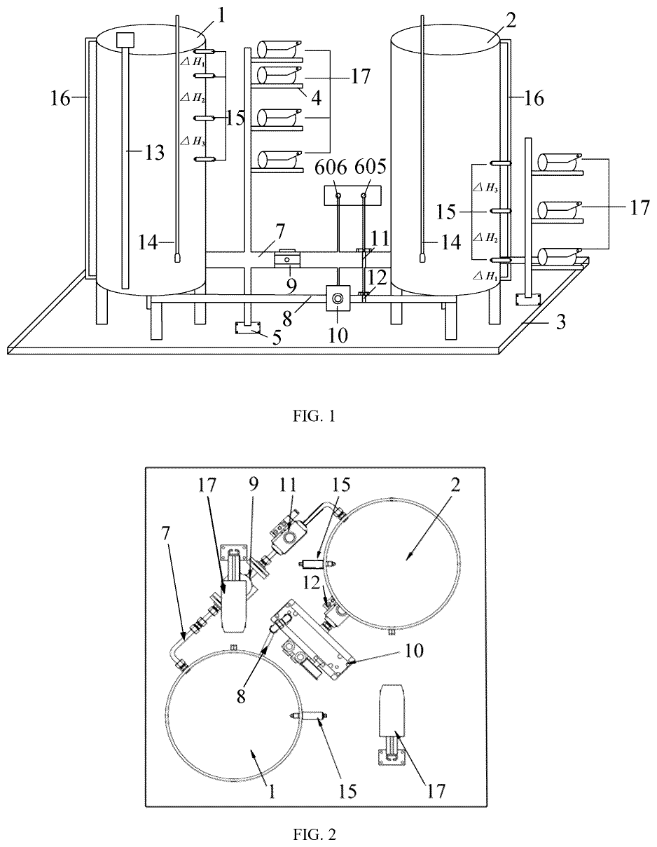

As shown in FIG. 1 and FIG. 2, a device includes first liquid reservoir 1, second liquid reservoir 2, a liquid level monitoring system, a flow monitoring system and a pumping system. The first liquid reservoir 1 and the second liquid reservoir 2 are provided with the liquid level monitoring system. An outlet end of the first liquid reservoir 1 communicates with an inlet end of the second liquid reservoir 2 through the flow monitoring system. An outlet end of the second liquid reservoir 2 communicates with an inlet end of the first liquid reservoir 1 through the pumping system. The first liquid reservoir 1, the second liquid reservoir 2 and the liquid level monitoring system are fixedly connected to base plate 3. The base plate 3 is disposed in a basket of geotechnical centrifuge 6. The liquid level monitoring system, the flow monitoring system and the pumping system are electrically connected to external control center 20. Signals from the liquid level monitoring system, the flow monitoring system and the pumping system are transmitted to the control center 20 through cable 19.

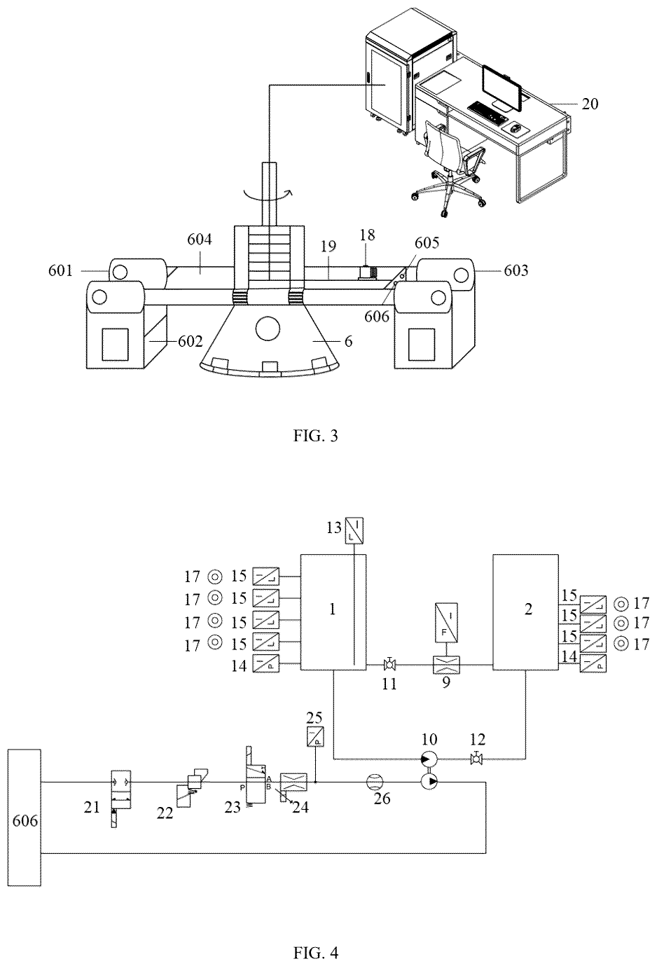

As shown in FIG. 3, the geotechnical centrifuge 6 includes first basket 601, second basket 603, and a centrifuge base. The first basket 601 and the second basket 603 are fixedly disposed on two sides of the centrifuge base via rotating arms 604, respectively. The first basket 601 is internally provided with counterweight 602. The entire device is disposed inside the second basket 603. The rotating arm 604 connecting the second basket 603 to the centrifuge base is provided with image acquisition device 18.

The liquid level monitoring system includes liquid level sensor 13, a first liquid level switch module, a second liquid level switch module, two liquid level tubes 16, and seven industrial cameras 17. The liquid level sensor 13 is disposed on an inner side wall of the first liquid reservoir 1, and is configured to measure a liquid level in the first liquid reservoir 1 in real time. The two liquid level tubes 16 are vertically disposed on side walls of the first liquid reservoir 1 and the second liquid reservoir 2, respectively, and are configured to observe liquid level changes in the first liquid reservoir 1 and the second liquid reservoir 2. The first liquid level switch module and the second liquid level switch module are disposed on the side walls of the first liquid reservoir 1 and the second liquid reservoir 2, respectively. The first liquid level switch module mainly includes four liquid level indicator lights 15 vertically arranged at intervals. The second liquid level switch module mainly includes three liquid level indicator lights 15 vertically arranged at intervals. When the liquid reaches a height of one corresponding liquid level indicator light 15, the corresponding liquid level indicator light 15 lights up. Otherwise, the liquid level indicator light 15 is off. The seven industrial cameras 17 are fixedly connected to the base plate 3 via bracket 4. A bottom of the bracket 4 is vertically fixedly connected to the base plate 3 via connector 5. The seven industrial cameras 17 are configured to acquire on/off states of the seven liquid level indicator lights 15, respectively. The number and distribution height of the industrial cameras 17 correspond to those of the liquid level indicator lights 15.

The liquid level sensor 13 and the industrial cameras 17 are electrically connected to the control center 20.

Using the equidistantly arranged liquid level indicator lights 15 as reference objects, the pitch angle observed by the industrial cameras 17 is calibrated under normal gravity to enable the industrial cameras 17 to read the liquid level readings within a certain range on the liquid level tubes 16. In the first liquid level switch module, the top liquid level indicator light 15 is disposed at the top of the first liquid reservoir 1, and the liquid level of this top liquid level indicator light 15 is denoted as target liquid level H. The liquid levels of the second, third, and fourth liquid level indicator lights 15 from top to bottom in the first liquid level switch module are denoted as H−ΔH₁, H−ΔH₁−ΔH₂, and H−ΔH₁−ΔH₂−ΔH₃, respectively, where ΔH₁ is the height difference between the first and second liquid level indicator lights 15, ΔH₂ is the height difference between the second and third liquid level indicator lights 15, and ΔH₃ is the height difference between the third and fourth liquid level indicator lights 15. In the second liquid level switch module, the liquid levels of the first, second, and third liquid level indicator lights 15 from the top are denoted as ΔH₁+ΔH₂+ΔH₃, ΔH₁+ΔH₂, and ΔH₁, respectively. One liquid level indicator light 15 from the first liquid level switch module and one liquid level indicator light 15 from the second liquid level switch module form a pair of liquid level indicator lights. The sum of the liquid levels of the two liquid level indicator lights 15 in the same pair is H.

The flow monitoring system includes flow pipe 7, flowmeter 9, and first pneumatic ball valve 11. The outlet end of the first liquid reservoir 1 communicates with the inlet end of the second liquid reservoir 2 through the flow pipe 7. The flowmeter 9 and the first pneumatic ball valve 11 are sequentially arranged on the flow pipe 7 from the first liquid reservoir 1 to the second liquid reservoir 2. A gas inlet end of the first pneumatic ball valve 11 communicates with gas outlet 605 of the geotechnical centrifuge 6. The gas outlet 605 of the geotechnical centrifuge 6 is configured to provide a gas source.

The device further includes two pressure sensors 14. The two pressure sensors 14 are fixedly connected inside the first liquid reservoir 1 and the second liquid reservoir 2, respectively, and the pressure sensors 14 are level with the flow pipe 7. The pressure sensors 14, the flowmeter 9 and the first pneumatic ball valve 11 are connected to the control center 20. The control center 20 is configured to control an opening degree of the first pneumatic ball valve 11, thereby controlling a fluid flow in the flow pipe 7.

The pumping system includes pumping pipe 8, flow pump 10, and second pneumatic ball valve 12. The outlet end of the second liquid reservoir 2 communicates with the inlet end of the first liquid reservoir 1 through the pumping pipe 8. The second pneumatic ball valve 12 and the flow pump 10 are sequentially arranged on the pumping pipe 8 from the second liquid reservoir 2 to the first liquid reservoir 1. A gas inlet end of the second pneumatic ball valve 12 communicates with the gas outlet 605 of the geotechnical centrifuge 6. An inlet end of the flow pump 10 is connected to oil outlet 606 of the geotechnical centrifuge 6. The oil outlet 606 of the geotechnical centrifuge 6 is configured to provide an oil source. The flow pump 10 and the second pneumatic ball valve 12 are connected to the control center 20. The control center 20 is configured to control an opening degree of the second pneumatic ball valve 12, thereby controlling a fluid flow in the pumping pipe 8.

The outlet end and the inlet end of the first liquid reservoir 1 are disposed on a bottom of the side wall and on a bottom surface of the first liquid reservoir 1, respectively. The inlet end and the outlet end of the second liquid reservoir 2 are disposed on a bottom of the side wall and on a bottom surface of the second liquid reservoir 2, respectively. As suspended pipes under hyper-gravity are vulnerable, whether to add support is considered based on actual lengths of the flow pipe 7 and the pumping pipe 8.

As shown in FIG. 4, the oil outlet 606 of the geotechnical centrifuge 6 communicates with the inlet end of the flow pump 10 through a main pipe. The main pipe from the oil outlet 606 to the flow pump is provided with electromagnetic ball valve 21, pressure reducing valve 22, reversing valve 23, proportional speed control valve 24, pressure sensor 25, and gear flowmeter 26 in sequence. The main pipe is disposed on the rotating arm 604 of the geotechnical centrifuge 6. The oil outlet 606 of the geotechnical centrifuge 6 further directly communicates with an oil inlet end of the flow pump 10 through a secondary pipe. The electromagnetic ball valve 21, the pressure reducing valve 22, the reversing valve 23, and the proportional speed control valve 24 are configured to adjust a hydraulic flow on the pipe. The pressure sensor 25 is configured to measure an inlet hydraulic pressure. The gear flowmeter 26 is configured to measure a flow of inlet hydraulic oil.

A method for measuring fluid flow and pressure under a hyper-gravity environment includes following steps.

First, the airtightness of the device is checked under normal gravity.

Step 1: Under normal gravity, clean water is injected into the first liquid reservoir 1 until the target liquid level H is reached. The target liquid level H corresponds to the height of the topmost liquid level indicator light 15 in the first liquid level switch module. When the topmost liquid level indicator light 15 in the first liquid level switch module lights up, water injection is stopped.

Step 2: The first pneumatic ball valve 11 is opened, allowing the liquid in the first liquid reservoir 1 to flow to the second liquid reservoir 2 through the flow pipe 7. When the liquid levels in the first liquid reservoir 1 and the second liquid reservoir 2 are equal, the liquid stops flowing. The first pneumatic ball valve 11 is closed, and the second pneumatic ball valve 12 is opened. The flow pump 10 pumps the water from the second liquid reservoir 2 back to the first liquid reservoir 1. After the water is completely pumped back to the first liquid reservoir 1, the second pneumatic ball valve 12 is closed, and the first pneumatic ball valve 11 is started.

Step 3: The step 2 is repeated multiple times to achieve water circulation between the first liquid reservoir 1 and the second liquid reservoir 2, thereby checking the airtightness of the first liquid reservoir 1, the second liquid reservoir 2, the flow pipe 7, and the pumping pipe 8.

Step 4: Response times and accuracy of the liquid level sensor 13, the liquid level indicator lights 15, the liquid level tubes 16, the industrial cameras 17, the flowmeter 9, the first pneumatic ball valve 11, the flow pump 10, and the second pneumatic ball valve 12 are tested.

When the airtightness and accuracy of each component in the device meet preset requirements, the method proceeds to the next step for a loading test under the hyper-gravity environment.

Step S1: A crane hoists the entire device into the second basket 603 of the geotechnical centrifuge 6. Clean water is injected into the first liquid reservoir 1 until the target liquid level H is reached while the liquid level in the second liquid reservoir 2 is 0. The liquid level monitoring system, the flow monitoring system and the pumping system are connected to the control center 20.

Step S2: The geotechnical centrifuge 6 is started. Under the hyper-gravity environment, the first pneumatic ball valve 11 is opened, allowing the liquid in the first liquid reservoir 1 to flow to the second liquid reservoir 2. Meanwhile, during liquid flowing, a qualification test is performed on the liquid level indicator lights 15 and the liquid level sensor 13.

Step S3: When the liquid levels in the first liquid reservoir 1 and the second liquid reservoir 2 are equal, the liquid stops flowing. At this point, the liquid levels in the first liquid reservoir 1 and the second liquid reservoir 2 are H/2. The first pneumatic ball valve 11 is closed, and the second pneumatic ball valve 12 is opened. The flow pump 10 pumps the water from the second liquid reservoir 2 back to the first liquid reservoir 1. Meanwhile, during liquid pumping, a qualification test is performed on the flow pump 10.

If the flow pump 10 is qualified, the method proceeds to step S4.

Otherwise, a test process is stopped, the unqualified flow pump 10 is replaced, and the step S3 is repeated until a test condition is met.

Step S4: The first pneumatic ball valve 11 is opened, allowing the liquid in the first liquid reservoir 1 to flow to the second liquid reservoir 2. Meanwhile, during liquid flowing, a qualification test is performed on the flowmeter 9 and the pressure sensors 14.

If the flowmeter 9 and the pressure sensors 14 are qualified, the method proceeds to step S5.

Otherwise, the test process is stopped, the unqualified flowmeter 9 or any unqualified pressure sensor 14 is replaced, and the step S4 is repeated until a test condition is met.

Step S5: When the liquid levels in the first liquid reservoir 1 and the second liquid reservoir 2 are equal, liquid flowing is stopped. The first pneumatic ball valve 11 is closed, and the second pneumatic ball valve 12 is opened. The flow pump 10 pumps the water from the second liquid reservoir 2 back to the first liquid reservoir 1. After the water is completely pumped back to the first liquid reservoir 1, the second pneumatic ball valve 12 is closed, and the first pneumatic ball valve 11 is started.

Step S6: The step S5 is repeated multiple times to achieve liquid circulation between the first liquid reservoir 1 and the second liquid reservoir 2. During liquid circulation, the pressure sensors 14, the gear flowmeter 26 and the flowmeter 9 respectively acquire a liquid pressure, a pumping flow of the flow pump 10, and a flow of the liquid under the action of a water head in real time.

Specifically, the step S2 is as follows.

Step S2.1: The geotechnical centrifuge 6 is started. A centrifugal acceleration of the geotechnical centrifuge 6 is gradually increased to a preset Ng value. After the centrifugal acceleration stabilizes for 15 min, the first pneumatic ball valve 11 is opened. The liquid in the first liquid reservoir 1 flows to the second liquid reservoir 2 through the flow pipe 7 under the action of a water head difference. Meanwhile, during liquid flowing, a qualification test is performed on the liquid level indicator lights 15 and the liquid level sensor 13.

The qualification test on the liquid level indicator lights 15 in the step S2.1 is specifically performed as follows. During liquid flowing, the industrial cameras 17 read readings of the transparent liquid level tubes 16 level with the industrial cameras 17, and the qualification test is performed on the liquid level indicator lights 15.

If the liquid level corresponding to the on/off state of the liquid level indicator light 15 is consistent with the liquid level in the liquid level tube 16, it indicates that the liquid level indicator light 15 is qualified.

Otherwise, it indicates that the liquid level indicator light 15 is unqualified.

Specifically, when the liquid reaches the height of one of the liquid level indicator lights 15, the corresponding liquid level indicator light 15 is in the on state. Otherwise, the liquid level indicator light 15 is in the off state. Therefore, the liquid level at that moment can be determined by the on/off state of the liquid level indicator lights 15. The industrial cameras 17 acquire the on/off states of the liquid level indicator lights 15 and the liquid levels in the liquid level tubes 16, and through a comparison, whether the liquid level indicator lights 15 are qualified can be determined.

If the liquid level indicator light 15 lights up when the liquid level in the liquid level tube 16 reaches the height of the liquid level indicator light 15 and the liquid level indicator light 15 is off when the liquid level in the liquid level tube 16 does not reach the height of the liquid level indicator light 15, it indicates that the liquid level indicator light 15 is qualified.

Otherwise, it indicates that the liquid level indicator light 15 is unqualified.

The qualification test on the liquid level sensor 13 in the step S2.1 is specifically performed as follows. During liquid flowing, the qualification test on the liquid level sensor 13 is performed based on the reading of the transparent liquid level tube 16.

If a reading of the liquid level sensor 13 is consistent with the liquid level in the liquid level tube 16, it indicates that the liquid level sensor 13 is qualified.

Otherwise, it indicates that the liquid level sensor 13 is unqualified.

Step S2.2: It is determined whether the liquid level switch module is qualified. The liquid level switch module is qualified if the seven liquid level indicator lights 15 meet following conditions.
I. The top liquid level indicator light 15 in the first liquid level switch module is qualified.
II. The first liquid level indicator light 15 from bottom to top in the first liquid level switch module is qualified or the second liquid level indicator light 15 from top to bottom in the second liquid level switch module is qualified.
III. The second liquid level indicator light 15 from bottom to top in the first liquid level switch module is qualified or the second liquid level indicator light 15 from top to bottom in the second liquid level switch module is qualified.
IV. The third liquid level indicator light 15 from bottom to top in the first liquid level switch module is qualified or the third liquid level indicator light 15 from top to bottom in the second liquid level switch module is qualified.

If the seven liquid level indicator lights 15 in the liquid level switch module meet the above four conditions, it indicates that the liquid level switch module is qualified. Otherwise, it indicates that the liquid level switch module is unqualified.

The liquid level switch module includes the first liquid level switch module and the second liquid level switch module.

Step S2.3: If at least one of the liquid level switch module and the liquid level sensor 13 is qualified, the method proceeds to step S3.

Otherwise, the test process is stopped, the unqualified liquid level sensor 13 or any unqualified liquid level indicator light 15 is replaced, and the steps S2.1 to S2.2 are repeated until the test conditions are met.

The qualification test on the flow pump 10 during liquid pumping in the step S3 is specifically performed as follows.

Step S3.1: The electromagnetic ball valve 21, the pressure reducing valve 22, and the reversing valve 23 are opened. The proportional speed control valve 24 is adjusted such that a reading of the gear flowmeter 26 reaches a preset pumping hydraulic flow value.

Step S3.2: A time when the second pneumatic ball valve 12 is opened is denoted as start time T₁, and a time when the liquid level in the first liquid reservoir 1 reaches the target liquid level H is denoted as end time T₂. At the end time, the liquid is completely pumped back to the first liquid reservoir 1. The second pneumatic ball valve 12 is closed. Theoretical pumping hydraulic flow Q is calculated as follows:

$$Q = \frac{A \cdot H}{2 ( {T}_{1} - {T}_{2} )}$$

where, A denotes a cross-sectional area of the first liquid reservoir 1.

Step S3.3: The theoretical pumping hydraulic flow Q is compared with the reading of the gear flowmeter 26.

If an error between the reading of the gear flowmeter 26 and the theoretical pumping hydraulic flow Q is within ±5%, it indicates that the flow pump 10 is qualified during liquid pumping.

Otherwise, it indicates that the flow pump 10 is unqualified.

The qualification test on the pressure sensors 14 in the step S4 is specifically performed as follows:

First, theoretical liquid pressure value Pₕ is calculated as follows:

$${P}_{h} = {ρω}^{2} ( {R}_{max} - {H}_{2} - \frac{h + {H}_{1}}{2} ) ( h - {H}_{1} )$$

where, Pₕ denotes a theoretical liquid pressure value corresponding to liquid level h; ρ denotes a liquid density; w denotes a rotational angular velocity of the geotechnical centrifuge 6; Rₘₐₓ denotes a distance from a rotation axis center of the geotechnical centrifuge 6 to a bottom surface of the second basket 603; h denotes a liquid level calculated by observing a real-time liquid level in the transparent liquid level tube 16; H₁ denotes a distance from the pressure sensor 14 to the bottom surface of the liquid reservoir 1 or the liquid reservoir 2; and H₂ denotes a distance from the bottom surface of the liquid reservoir 1 or the liquid reservoir 2 to the bottom surface of the second basket 603.

Then, the theoretical liquid pressure value Pₕ is compared with readings of the pressure sensors 14 at a same liquid level:

If an error between readings of the pressure sensors 14 and the theoretical pressure value Pₕ is within ±5%, it indicates that the pressure sensors 14 are qualified.

Otherwise, it indicates that the pressure sensors 14 are unqualified.

The qualification test on the flowmeter 9 in the step S4 includes following two methods.

Method 1: If the liquid level switch module is qualified in the step S2.2, the qualification test on the flowmeter 9 is performed through the liquid level indicator lights 15.

Step S4.1: Timing is started when the first pneumatic ball valve 11 is opened. Readings of the flowmeter 9 are recorded every 1 s. When the liquid level in the first liquid reservoir 1 changes to the height of each of the qualified liquid level indicator lights 15 in the liquid level switch module, corresponding liquid level change time difference Δtᵢ (i=1, 2, 3) is recorded, and theoretical flow Q′ is calculated:

$${Q}^{′} = \frac{A \cdot {ΔH}_{1}}{3 Δ {t}_{1}} + \frac{A \cdot {ΔH}_{2}}{3 Δ {t}_{2}} + \frac{A \cdot {ΔH}_{3}}{3 Δ {t}_{2}}$$

where, Δt₁ denotes a time required for the liquid level in the first liquid reservoir 1 to drop by ΔH₁; Δt₂ denotes a time required for the liquid level in the first liquid reservoir 1 to drop by ΔH₂; Δt₃ denotes a time required for the liquid level in the first liquid reservoir 1 to drop by ΔH₃; ΔH₁ denotes the height difference between the first and second liquid level indicator lights 15 from top to bottom in the first liquid level switch module; ΔH₂ denotes the height difference between the second and third liquid level indicator lights 15 from top to bottom in the first liquid level switch module; and ΔH₃ denotes the height difference between the third and fourth liquid level indicator lights 15 from top to bottom in the first liquid level switch module.

Specifically, Δt₁ denotes the time required for the liquid level in the first liquid reservoir 1 to drop from the first liquid level indicator light 15 from top to bottom to the second liquid level indicator light 15 in the first liquid level switch module; Δt₂ denotes the time required for the liquid level in the first liquid reservoir 1 to drop from the second liquid level indicator light 15 from top to bottom to the third liquid level indicator light 15 in the first liquid level switch module; and Δt₃ denotes the time required for the liquid level in the first liquid reservoir 1 to drop from the third liquid level indicator light 15 from top to bottom to the fourth liquid level indicator light 15 in the first liquid level switch module.

Step S4.2: The theoretical flow Q′ is compared with a reading of the flowmeter 9.

If an error between the reading of the flowmeter 9 and the theoretical flow Q′ is within ±5%, it indicates that the flowmeter 9 is qualified.

Otherwise, it indicates that the flowmeter 9 is unqualified.

Method 2: If the liquid level sensor 13 is qualified in the step S2.1, the qualification test is performed on the flowmeter 9 through the liquid level sensor 13.

Step S4.1: Timing is started when the first pneumatic ball valve 11 is opened. A reading change of the liquid level sensor 13 within random time period δt is acquired, and the theoretical flow Q′ is calculated as follows:

$${Q}^{′} = \frac{A \cdot {H}_{δ t}}{δ t}$$

where, H_{δt} denotes a difference in readings of the liquid level sensor 13 during the time period δt.

Step S4.2: The theoretical flow Q′ is compared with the reading of the flowmeter 9.

If the error between the reading of the flowmeter 9 and the theoretical flow Q′ is within ±5%, it indicates that the flowmeter 9 is qualified.

Otherwise, it indicates that the flowmeter 9 is unqualified.

If both the liquid level sensor 13 and the liquid level switch module are qualified, the determination result of the liquid level sensor 13 for the flowmeter 9 prevails.

Those skilled in the art can easily make various changes and modifications based on the written description, drawings, and claims provided by the present disclosure, without departing from the spirit and scope of the present disclosure as defined by the claims. Any modifications or equivalent changes made to the above-described embodiments based on the technical idea and essence of the present disclosure shall fall within the protection scope defined by the claims of the present disclosure.

1. A device for measuring fluid flow and pressure under a hyper-gravity environment, comprising:
a first liquid reservoir, a second liquid reservoir, a liquid level monitoring system, a flow monitoring system and a pumping system, wherein the first liquid reservoir and the second liquid reservoir are provided with the liquid level monitoring system; an outlet end of the first liquid reservoir communicates with an inlet end of the second liquid reservoir through the flow monitoring system; an outlet end of the second liquid reservoir communicates with an inlet end of the first liquid reservoir through the pumping system; the first liquid reservoir, the second liquid reservoir and the liquid level monitoring system are fixedly connected to a base plate; the base plate is disposed in a basket of a geotechnical centrifuge; and the liquid level monitoring system, the flow monitoring system and the pumping system are electrically connected to an external control center;
the liquid level monitoring system comprises a liquid level sensor, a first liquid level switch module, a second liquid level switch module, two liquid level tubes, and seven industrial cameras; the liquid level sensor is disposed on an inner side wall of the first liquid reservoir, and is configured to measure a liquid level in the first liquid reservoir in real time; the two liquid level tubes are vertically disposed on side walls of the first liquid reservoir and the second liquid reservoir, respectively, and are configured to observe liquid level changes in the first liquid reservoir and the second liquid reservoir, respectively; the first liquid level switch module and the second liquid level switch module are disposed on the side walls of the first liquid reservoir and the second liquid reservoir, respectively; the first liquid level switch module comprises four liquid level indicator lights vertically arranged at intervals; the second liquid level switch module comprises three liquid level indicator lights vertically arranged at intervals; the seven industrial cameras are fixedly connected to the base plate via a bracket; the seven industrial cameras are configured to acquire on/off states of the seven liquid level indicator lights, respectively; and the liquid level sensor and the industrial cameras are electrically connected to the control center;
the flow monitoring system comprises a flow pipe, a flowmeter, and a first pneumatic ball valve; the outlet end of the first liquid reservoir communicates with the inlet end of the second liquid reservoir through the flow pipe; the flowmeter and the first pneumatic ball valve are sequentially arranged on the flow pipe from the first liquid reservoir to the second liquid reservoir; and a gas inlet end of the first pneumatic ball valve communicates with a gas outlet of the geotechnical centrifuge; and
the device further comprises two first pressure sensors; the two first pressure sensors are fixedly connected inside the first liquid reservoir and the second liquid reservoir, respectively; the first pressure sensors are level with the flow pipe; the first pressure sensors, the flowmeter and the first pneumatic ball valve are connected to the control center; and the control center is configured to control an opening degree of the first pneumatic ball valve, thereby controlling a fluid flow in the flow pipe; and
an oil outlet of the geotechnical centrifuge communicates with an inlet end of a flow pump through a main pipe; an electromagnetic ball valve, a pressure reducing valve, a reversing valve, a proportional speed control valve, a second pressure sensor and a gear flowmeter are sequentially arranged on the main pipe from the oil outlet to the flow pump; and the oil outlet of the geotechnical centrifuge further directly communicates with an oil inlet end of the flow pump through a secondary pipe.

2. The device for measuring fluid flow and pressure under the hyper-gravity environment according to claim 1, wherein the pumping system comprises a pumping pipe, a flow pump, and a second pneumatic ball valve; the outlet end of the second liquid reservoir communicates with the inlet end of the first liquid reservoir through the pumping pipe; the second pneumatic ball valve and the flow pump are sequentially arranged on the pumping pipe from the second liquid reservoir to the first liquid reservoir; a gas inlet end of the second pneumatic ball valve communicates with a gas outlet of the geotechnical centrifuge; an inlet end of the flow pump is connected to an oil outlet of the geotechnical centrifuge; the flow pump and the second pneumatic ball valve are connected to the control center; and the control center is configured to control an opening degree of the second pneumatic ball valve, thereby controlling a fluid flow in the pumping pipe.

3. A method for measuring fluid flow and pressure under a hyper-gravity environment, applied to the device according to claim 1, and comprising following steps:
step S1: hoisting, by a crane, the entire device into a second basket of the geotechnical centrifuge; injecting clean water into the first liquid reservoir until a target liquid level H is reached; and connecting the liquid level monitoring system, the flow monitoring system and the pumping system to the control center;
step S2: starting the geotechnical centrifuge; opening a first pneumatic ball valve under the hyper-gravity environment, allowing a liquid in the first liquid reservoir to flow to the second liquid reservoir; and performing, during liquid flowing, a qualification test on liquid level indicator lights and a liquid level sensor;
step S3: closing the first pneumatic ball valve and opening a second pneumatic ball valve when liquid levels in the first liquid reservoir and the second liquid reservoir are equal and the liquid stops flowing; pumping, by a flow pump, water from the second liquid reservoir back to the first liquid reservoir; and performing, during liquid pumping, a qualification test on the flow pump;
proceeding to step S4 if the flow pump is qualified; and
otherwise, stopping a test process, replacing the unqualified flow pump, and repeating the step S3 until a test condition is met;
step S4: opening the first pneumatic ball valve, allowing the liquid in the first liquid reservoir to flow to the second liquid reservoir; and performing, during liquid flowing, a qualification test on a flowmeter and first pressure sensors;
proceeding to step S5 if the flowmeter and the first pressure sensors are qualified; and
otherwise, stopping the test process, replacing the unqualified flowmeter or any unqualified first pressure sensor, and repeating the step S4 until a test condition is met;
step S5: closing the first pneumatic ball valve and opening the second pneumatic ball valve, when the liquid levels in the first liquid reservoir and the second liquid reservoir are equal and the liquid stops flowing; pumping, by the flow pump, the water from the second liquid reservoir back to the first liquid reservoir; and closing the second pneumatic ball valve and starting the first pneumatic ball valve after the water is completely pumped back to the first liquid reservoir; and
step S6: repeating the step S5 multiple times to achieve liquid circulation between the first liquid reservoir and the second liquid reservoir; and acquiring, during liquid circulation, a liquid pressure, a pumping flow of the flow pump, and a flow of the liquid under an action of a water head in real time by the first pressure sensors, a gear flowmeter and the flowmeter, respectively.

4. The method for measuring fluid flow and pressure under the hyper-gravity environment according to claim 3, wherein the step S2 comprises:
step S2.1: starting the geotechnical centrifuge; gradually increasing a centrifugal acceleration of the geotechnical centrifuge to a preset Ng value; opening the first pneumatic ball valve after the centrifugal acceleration stabilizes, allowing the liquid in the first liquid reservoir to flow to the second liquid reservoir through a flow pipe under an action of a water head difference; and performing, during liquid flowing, a qualification test on the liquid level indicator lights and the liquid level sensor;
wherein, the qualification test on the liquid level indicator lights in the step S2.1 is performed as follows: performing, during liquid flowing, the qualification test on the liquid level indicator lights based on readings of transparent liquid level tubes:
determining that, if a liquid level corresponding to an on/off state of the liquid level indicator light is consistent with a liquid level in the liquid level tube, the liquid level indicator light is qualified; and
otherwise, determining that the liquid level indicator light is unqualified; and
the qualification test on the liquid level sensor in the step S2.1 is performed as follows: performing, during liquid flowing, the qualification test on the liquid level sensor based on the reading of the transparent liquid level tube:
determining that, if a reading of the liquid level sensor is consistent with the liquid level in the liquid level tube, the liquid level sensor is qualified; and
otherwise, determining that the liquid level sensor is unqualified;
step S2.2: determining whether a liquid level switch module is qualified, wherein the liquid level switch module is qualified if the seven liquid level indicator lights meet following conditions:
a top liquid level indicator light in the first liquid level switch module is qualified;
a first liquid level indicator light from bottom to top in the first liquid level switch module is qualified or a first liquid level indicator light from top to bottom in the second liquid level switch module is qualified;
a second liquid level indicator light from bottom to top in the first liquid level switch module is qualified or a second liquid level indicator light from top to bottom in the second liquid level switch module is qualified; and
a third liquid level indicator light from bottom to top in the first liquid level switch module is qualified or a third liquid level indicator light from top to bottom in the second liquid level switch module is qualified; and
determining that, if the seven liquid level indicator lights in the liquid level switch module meet the above four conditions, the liquid level switch module is qualified; and otherwise, determining that the liquid level switch module is unqualified; and
step S2.3: proceeding to the step S3 if at least one of the liquid level switch module and the liquid level sensor is qualified; and
otherwise, stopping the test process, replacing the unqualified liquid level sensor or any unqualified liquid level indicator light, and repeating the steps S2.1 to S2.2 until a test condition is met.

5. The method for measuring fluid flow and pressure under the hyper-gravity environment according to claim 3, wherein the qualification test on the flow pump during liquid pumping in the step S3 is performed as follows:
step S3.1: opening an electromagnetic ball valve, a pressure reducing valve, and a reversing valve; and adjusting a proportional speed control valve such that a reading of the gear flowmeter reaches a preset pumping hydraulic flow value;
step S3.2: denoting a time when the second pneumatic ball valve is opened as a start time T₁, and denoting a time when the liquid level in the first liquid reservoir reaches the target liquid level H as an end time T₂; and closing the second pneumatic ball valve, and acquiring a theoretical pumping hydraulic flow Q according to the following formula:
$$Q = \frac{A \cdot H}{2 ( {T}_{1} - {T}_{2} )} ,$$
wherein A denotes a cross-sectional area of the first liquid reservoir; and
step S3.3: comparing the theoretical pumping hydraulic flow Q with the reading of the gear flowmeter;
determining that, if an error between the reading of the gear flowmeter and the theoretical pumping hydraulic flow Q is within ±5%, the flow pump is qualified during liquid pumping; and
otherwise, determining that the flow pump is unqualified.

6. The method for measuring fluid flow and pressure under the hyper-gravity environment according to claim 3, wherein the qualification test on the first pressure sensors in the step S4 is performed as follows:
acquiring a theoretical liquid pressure value Pₕ according to the following formula:
$${P}_{h} = {ρω}^{2} ( {R}_{max} - {H}_{2} - \frac{h + {H}_{1}}{2} ) ( h - {H}_{1} ) ,$$
wherein Pₕ denotes a theoretical liquid pressure value corresponding to a liquid level h; ρ denotes a liquid density; ω denotes a rotational angular velocity of the geotechnical centrifuge; Rₘₐₓ denotes a distance from a rotation axis center of the geotechnical centrifuge to a bottom surface of the second basket; h denotes a liquid level; H₁ denotes a distance from the first pressure sensor to a bottom surface of the liquid reservoir (, 2); and H₂ denotes a distance from the bottom surface of the liquid reservoir (, 2) to the bottom surface of the second basket;
comparing the theoretical liquid pressure value Pₕ with readings of the first pressure sensors at a same liquid level:
determining that, if an error between the readings of the first pressure sensors and the theoretical pressure value Pₕ is within ±5%, the first pressure sensors are qualified; and
otherwise, determining that the first pressure sensors are unqualified.

7. The method for measuring fluid flow and pressure under the hyper-gravity environment according to claim 3, wherein the qualification test on the flowmeter in the step S4 is performed as follows:
performing, if the liquid level switch module in the step S2.2 is qualified, the qualification test on the flowmeter through the liquid level indicator lights:
step S4.1: starting timing when the first pneumatic ball valve is opened; recording readings of the flowmeter every 1 s; recording a corresponding liquid level change time difference Δtᵢ (i=1, 2, 3) when the liquid level in the first liquid reservoir changes to a height of each of the qualified liquid level indicator lights in the liquid level switch module; and calculating a theoretical flow Q′ according to the following formula:
$${Q}^{′} = \frac{A \cdot {ΔH}_{1}}{3 Δ {t}_{1}} + \frac{A \cdot {ΔH}_{2}}{3 Δ {t}_{2}} + \frac{A \cdot {ΔH}_{3}}{3 Δ {t}_{2}} ,$$
wherein Δt₁ denotes a time required for the liquid level in the first liquid reservoir to drop by ΔH₁; Δt₂ denotes a time required for the liquid level in the first liquid reservoir to drop by ΔH₂; Δt₃ denotes a time required for the liquid level in the first liquid reservoir to drop by ΔH₃; ΔH₁ denotes a height difference between the first liquid level indicator light and the second liquid level indicator light from top to bottom in the first liquid level switch module; ΔH₂ denotes a height difference between the second liquid level indicator light and the third liquid level indicator light from top to bottom in the first liquid level switch module; and ΔH₃ denotes a height difference between the third liquid level indicator light and a fourth liquid level indicator light from top to bottom in the first liquid level switch module;
step S4.2: comparing the theoretical flow Q′ with a reading of the flowmeter;
determining that, if an error between the reading of the flowmeter and the theoretical flow Q′ is within ±5%, the flowmeter is qualified; and
otherwise, determining that the flowmeter is unqualified; and
performing, if the liquid level sensor is qualified in the step S2.1, the qualification test on the flowmeter through the liquid level sensor:
step S4.1: starting timing when the first pneumatic ball valve is opened, acquiring a reading change of the liquid level sensor within a random time period δₜ, and calculating a theoretical flow Q′ according to the following formula:
$${Q}^{′} = \frac{A \cdot {H}_{δ t}}{δ t} ,$$
wherein H_{δt} denotes a difference in readings of the liquid level sensor during the time period δt; and
step S4.2: comparing the theoretical flow Q′ with the reading of the flowmeter;
determining that, if an error between the reading of the flowmeter and the theoretical flow Q′ is within ±5%, the flowmeter is qualified; and
otherwise, determining that the flowmeter is unqualified.

8. A method for measuring fluid flow and pressure under a hyper-gravity environment, applied to the device according to claim 2, and comprising following steps:
step S1: hoisting, by a crane, the entire device into a second basket of the geotechnical centrifuge; injecting clean water into the first liquid reservoir until a target liquid level H is reached; and connecting the liquid level monitoring system, the flow monitoring system and the pumping system to the control center;
step S2: starting the geotechnical centrifuge; opening a first pneumatic ball valve under the hyper-gravity environment, allowing a liquid in the first liquid reservoir to flow to the second liquid reservoir; and performing, during liquid flowing, a qualification test on liquid level indicator lights and a liquid level sensor;
step S3: closing the first pneumatic ball valve and opening a second pneumatic ball valve when liquid levels in the first liquid reservoir and the second liquid reservoir are equal and the liquid stops flowing; pumping, by a flow pump, water from the second liquid reservoir back to the first liquid reservoir; and performing, during liquid pumping, a qualification test on the flow pump;
proceeding to step S4 if the flow pump is qualified; and
otherwise, stopping a test process, replacing the unqualified flow pump, and repeating the step S3 until a test condition is met;
step S4: opening the first pneumatic ball valve, allowing the liquid in the first liquid reservoir to flow to the second liquid reservoir; and performing, during liquid flowing, a qualification test on a flowmeter and first pressure sensors;
proceeding to step S5 if the flowmeter and the first pressure sensors are qualified; and
otherwise, stopping the test process, replacing the unqualified flowmeter or any unqualified first pressure sensor, and repeating the step S4 until a test condition is met;
step S5: closing the first pneumatic ball valve and opening the second pneumatic ball valve, when the liquid levels in the first liquid reservoir and the second liquid reservoir are equal and the liquid stops flowing; pumping, by the flow pump, the water from the second liquid reservoir back to the first liquid reservoir; and closing the second pneumatic ball valve and starting the first pneumatic ball valve after the water is completely pumped back to the first liquid reservoir; and
step S6: repeating the step S5 multiple times to achieve liquid circulation between the first liquid reservoir and the second liquid reservoir; and acquiring, during liquid circulation, a liquid pressure, a pumping flow of the flow pump, and a flow of the liquid under an action of a water head in real time by the first pressure sensors, a gear flowmeter and the flowmeter, respectively.

9. The method for measuring fluid flow and pressure under the hyper-gravity environment according to claim 8, wherein the step S2 comprises:
step S2.1: starting the geotechnical centrifuge; gradually increasing a centrifugal acceleration of the geotechnical centrifuge to a preset Ng value; opening the first pneumatic ball valve after the centrifugal acceleration stabilizes, allowing the liquid in the first liquid reservoir to flow to the second liquid reservoir through a flow pipe under an action of a water head difference; and performing, during liquid flowing, a qualification test on the liquid level indicator lights and the liquid level sensor;
wherein, the qualification test on the liquid level indicator lights in the step S2.1 is performed as follows: performing, during liquid flowing, the qualification test on the liquid level indicator lights based on readings of transparent liquid level tubes:
determining that, if a liquid level corresponding to an on/off state of the liquid level indicator light is consistent with a liquid level in the liquid level tube, the liquid level indicator light is qualified; and
otherwise, determining that the liquid level indicator light is unqualified; and
the qualification test on the liquid level sensor in the step S2.1 is performed as follows: performing, during liquid flowing, the qualification test on the liquid level sensor based on the reading of the transparent liquid level tube:
determining that, if a reading of the liquid level sensor is consistent with the liquid level in the liquid level tube, the liquid level sensor is qualified; and
otherwise, determining that the liquid level sensor is unqualified;
step S2.2: determining whether a liquid level switch module is qualified, wherein the liquid level switch module is qualified if the seven liquid level indicator lights meet following conditions:
a top liquid level indicator light in the first liquid level switch module is qualified;
a first liquid level indicator light from bottom to top in the first liquid level switch module is qualified or a first liquid level indicator light from top to bottom in the second liquid level switch module is qualified;
a second liquid level indicator light from bottom to top in the first liquid level switch module is qualified or a second liquid level indicator light from top to bottom in the second liquid level switch module is qualified; and
a third liquid level indicator light from bottom to top in the first liquid level switch module is qualified or a third liquid level indicator light from top to bottom in the second liquid level switch module is qualified; and
determining that, if the seven liquid level indicator lights in the liquid level switch module meet the above four conditions, the liquid level switch module is qualified; and otherwise, determining that the liquid level switch module is unqualified; and
step S2.3: proceeding to the step S3 if at least one of the liquid level switch module and the liquid level sensor is qualified; and
otherwise, stopping the test process, replacing the unqualified liquid level sensor or any unqualified liquid level indicator light, and repeating the steps S2.1 to S2.2 until a test condition is met.

10. The method for measuring fluid flow and pressure under the hyper-gravity environment according to claim 8, wherein the qualification test on the flow pump during liquid pumping in the step S3 is performed as follows:
step S3.1: opening an electromagnetic ball valve, a pressure reducing valve, and a reversing valve; and adjusting a proportional speed control valve such that a reading of the gear flowmeter reaches a preset pumping hydraulic flow value;
step S3.2: denoting a time when the second pneumatic ball valve is opened as a start time T₁, and denoting a time when the liquid level in the first liquid reservoir reaches the target liquid level H as an end time T₂; and closing the second pneumatic ball valve, and acquiring a theoretical pumping hydraulic flow Q according to the following formula:
$$Q = \frac{A \cdot H}{2 ( {T}_{1} - {T}_{2} )} ,$$
wherein A denotes a cross-sectional area of the first liquid reservoir; and
step S3.3: comparing the theoretical pumping hydraulic flow Q with the reading of the gear flowmeter;
determining that, if an error between the reading of the gear flowmeter and the theoretical pumping hydraulic flow Q is within ±5%, the flow pump is qualified during liquid pumping; and
otherwise, determining that the flow pump is unqualified.

11. The method for measuring fluid flow and pressure under the hyper-gravity environment according to claim 8, wherein the qualification test on the first pressure sensors in the step S4 is performed as follows:
acquiring a theoretical liquid pressure value Pₕ according to the following formula:
$${P}_{h} = {ρω}^{2} ( {R}_{max} - {H}_{2} - \frac{h + {H}_{1}}{2} ) ( h - {H}_{1} ) ,$$
wherein Pₕ denotes a theoretical liquid pressure value corresponding to a liquid level h; ρ denotes a liquid density; ω denotes a rotational angular velocity of the geotechnical centrifuge; Rₘₐₓ denotes a distance from a rotation axis center of the geotechnical centrifuge to a bottom surface of the second basket; h denotes a liquid level; H₁ denotes a distance from the first pressure sensor to a bottom surface of the liquid reservoir (, 2); and H₂ denotes a distance from the bottom surface of the liquid reservoir (, 2) to the bottom surface of the second basket;
comparing the theoretical liquid pressure value Pₕ with readings of the first pressure sensors at a same liquid level:
determining that, if an error between the readings of the first pressure sensors and the theoretical pressure value Pₕ is within ±5%, the first pressure sensors are qualified; and
otherwise, determining that the first pressure sensors are unqualified.

12. The method for measuring fluid flow and pressure under the hyper-gravity environment according to claim 8, wherein the qualification test on the flowmeter in the step S4 is performed as follows:
performing, if the liquid level switch module in the step S2.2 is qualified, the qualification test on the flowmeter through the liquid level indicator lights:
step S4.1: starting timing when the first pneumatic ball valve is opened; recording readings of the flowmeter every 1 s; recording a corresponding liquid level change time difference Δtᵢ (i=1, 2, 3) when the liquid level in the first liquid reservoir changes to a height of each of the qualified liquid level indicator lights in the liquid level switch module; and calculating a theoretical flow Q′ according to the following formula:
$${Q}^{′} = \frac{A \cdot {ΔH}_{1}}{3 Δ {t}_{1}} + \frac{A \cdot {ΔH}_{2}}{3 Δ {t}_{2}} + \frac{A \cdot {ΔH}_{3}}{3 Δ {t}_{2}} ,$$
wherein Δt₁ denotes a time required for the liquid level in the first liquid reservoir to drop by ΔH₁; Δt₂ denotes a time required for the liquid level in the first liquid reservoir to drop by ΔH₂; Δt₃ denotes a time required for the liquid level in the first liquid reservoir to drop by ΔH₃; ΔH₁ denotes a height difference between the first liquid level indicator light and the second liquid level indicator light from top to bottom in the first liquid level switch module; ΔH₂ denotes a height difference between the second liquid level indicator light and the third liquid level indicator light from top to bottom in the first liquid level switch module; and ΔH₃ denotes a height difference between the third liquid level indicator light and a fourth liquid level indicator light from top to bottom in the first liquid level switch module;
step S4.2: comparing the theoretical flow Q′ with a reading of the flowmeter;
determining that, if an error between the reading of the flowmeter and the theoretical flow Q′ is within ±5%, the flowmeter is qualified; and
otherwise, determining that the flowmeter is unqualified; and
performing, if the liquid level sensor is qualified in the step S2.1, the qualification test on the flowmeter through the liquid level sensor:
step S4.1: starting timing when the first pneumatic ball valve is opened, acquiring a reading change of the liquid level sensor within a random time period δt, and calculating a theoretical flow Q′ according to the following formula:
$${Q}^{′} = \frac{A \cdot {H}_{δ t}}{δ t} ,$$
wherein H_{δt} denotes a difference in readings of the liquid level sensor during the time period δt; and
step S4.2: comparing the theoretical flow Q′ with the reading of the flowmeter;
determining that, if an error between the reading of the flowmeter and the theoretical flow Q′ is within ±5%, the flowmeter is qualified; and
otherwise, determining that the flowmeter is unqualified.
